(19) United States
(12) Patent Application Publication
(10) Pub. No.: US 2009/0251427 A1
(43) Pub. Date: Oct. 8, 2009

(54) Power reduction of a capacitive touch system

(76) Inventors: Tse-Lun Hung, Taipei City (TW); Jung-Shou Huang, Da-an Shiang (TW); Chang-Hsin Chen, Shalu Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,093

(22) Filed: Mar. 31, 2009

(30) Foreign Application Priority Data
Apr. 2, 2008 (TW) 097112062

(51) Int. Cl. G06F 3/041

(52) U.S. Cl. 345/173

(57) ABSTRACT

A capacitive touch system uses at least two integrated circuits to simultaneously scan a touch panel, each of the integrated circuits scanning only a portion of the touch panel. If any one of the integrated circuits has not detected any objects on its scanning zone for a long time, it will enter a suspend mode to lower the scanning frequency thereof for power saving.

### FIELD OF THE INVENTION

The present invention is related generally to a capacitive touch system and, more particularly, to power reduction of a capacitive touch system.

### BACKGROUND OF THE INVENTION

In conventional applications, all the large scale capacitive touch panels use a surface capacitance sensing technique to scan thereto for determining a touch information, which uses a set of sensing currents, each directed to an endpoint of the large scale touch panel to produce sensed values, and therefore, even multiple fingers simultaneously touch the large scale touch panel, this sensing technique still retrieves only one set of sensed currents in response to this multi-finger touch. For this reason, the surface capacitance sensing technique can identify only one set of absolute coordinates. In a two dimensional matrix for instance, only one set of parameters (X,Y) will be determined, and thereby it can't implement a multi-finger touch detection.

An all points addressable (APA) projected capacitance sensing technique is capable of implementing a multi-finger touch detection, but not applicable to large scale touch panels because, to implement this sensing technique, it is necessary to charge and discharge each point sensor on the large scale touch panel. Taking a matrix-type touch panel for example, when the X and Y traces increase, the pixel number of an APA projected capacitance touch panel dramatically increases and thereby significantly degrades the frame rate of the touch panel due to the very long time period for scanning the large scale touch panel in a frame.

An axis intersect (AI) projected capacitance sensing technique is also capable of implementing a multi-finger touch detection, but not applicable to large scale touch panels, too. FIG. 1 is a schematic diagram of a conventional AI projected capacitance sensing technique applied to a small scale touch panel 10, in which an AI projected capacitance touch IC 12 is used to scan the small scale touch panel 10. Assuming that the AI projected capacitance touch IC 12 can support up to 22 traces, a good frame rate can be attained for a small scale touch panel 10 having ten X traces TRX1-TRX10 and ten Y traces TRY1-TRY10. However, if a this type touch IC 12 is applied to a large scale touch panel 14 having forty X traces TRX1-TRX40 and forty Y traces TRY1-TRY40, as shown in FIG. 2, the total number of traces that the touch IC 12 needs to scan dramatically increases. Unfortunately, the frame rate of the overall touch panel application is dependent to a very large extent on the time it takes the touch IC 12 to charge and discharge capacitors each time. In other words, the frame rate is determined mainly by the time in a frame that the touch IC 12 charges and discharges the capacitors. Hence, if an AI projected capacitance touch IC capable of scanning a greater number of traces is applied to a large scale touch panel 14, a major drawback would be a significantly decreased frame rate in the overall application, which leads to compromised performance at the application end.

### SUMMARY OF THE INVENTION

An object of the present invention is to provide a power saving capacitive touch system and a power saving method for a capacitive touch system.

According to the present invention, a capacitive touch system includes at least two first integrated circuits to simultaneously scan a touch panel, each of the first integrated circuits scanning only a portion of the touch panel, and a second integrated circuit to receive sensed data from the first integrated circuits and calculate therewith. If any one of the integrated circuits has not detected any objects on its scanning zone for a long time, it will enter a suspend mode to lower the scanning frequency thereof for power saving.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a schematic diagram of a conventional AI projected capacitance sensing technique applied to a small scale touch panel;

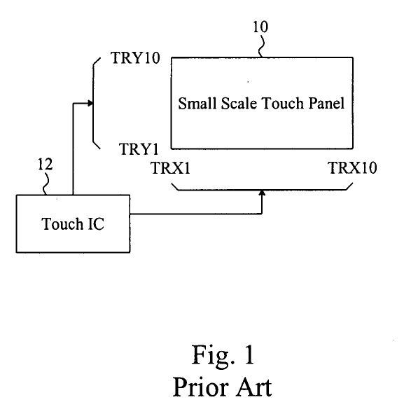

FIG. 2 is a schematic diagram of a conventional AI projected capacitance sensing technique applied to a large scale touch panel;

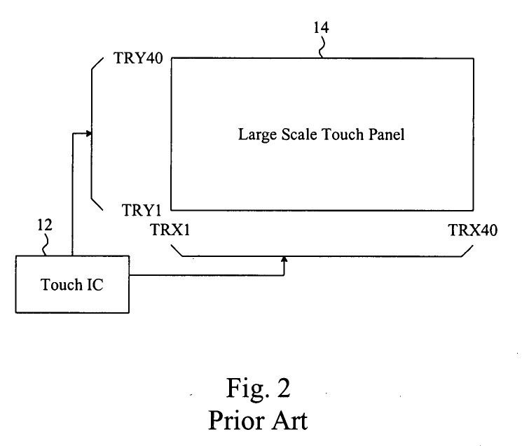

FIG. 3 is a schematic diagram of a capacitive touch system using at least two AI projected capacitance touch ICs to scan a touch panel;

FIG. 4 is a schematic diagram of an embodiment according to the present invention, which adds a suspend mode into a capacitive touch system to reduce the overall power consumption of the capacitive touch system; and

FIG. 5 is a timing diagram of the sensed data sent by a slave touch IC to a master touch IC under normal mode.

### DETAILED DESCRIPTION OF THE INVENTION

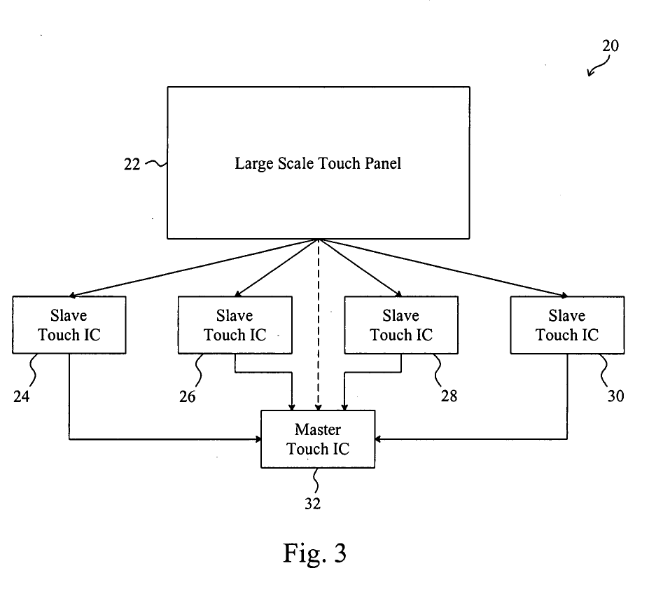

According to the present invention, as shown in FIG. 3, a capacitive touch system 20 uses four AI projected capacitance touch ICs 24, 26, 28 and 30 to simultaneously scan a large scale touch panel 22 to increase the frame rate of the capacitive touch system 20. Assuming that the large scale touch panel 22 has eighty traces, for example, given the order numbers of 1-80, each of the touch ICs 24-30 is responsible for scanning respective twenty traces. Each of the touch ICs 24-30 is a slave touch IC, scans the traces in one or more directions, and transmits its sensed values to a master touch IC 32 where the received sensed values are used for final and overall calculation, and subsequent actions may be determined for intended applications. The master touch IC 32 is also responsible for coordinating the overall operation of the capacitive touch system 20 and external communications. If needed, the master touch IC 32 may also take part in scanning, as indicated by the dashed line in FIG. 3. Alternatively, the slave touch ICs 24-30 may share some calculation to reduce the loading of the master touch IC 32.

The touched area of a user's finger is very small in comparison with the entire area of the large scale touch panel 22, and in most applications, the user's finger usually operates on only some local portions of the large scale touch panel 22. Therefore, most of the slave touch ICs 24-30 can enter a suspend mode for most of the time for power saving. For example, if some of the scanning zones of the slave touch ICs 24-30 have not been touched for a long time, the responsible slave touch ICs for those scanning zones may enter the suspend mode and thereafter scans their responsible scanning zones at a longer interval. For example, each of the slave touch ICs 24-30 scans its responsible scanning zone at an interval of about 4 ms in a normal mode, but at an interval of about 40 ms in the suspend mode.

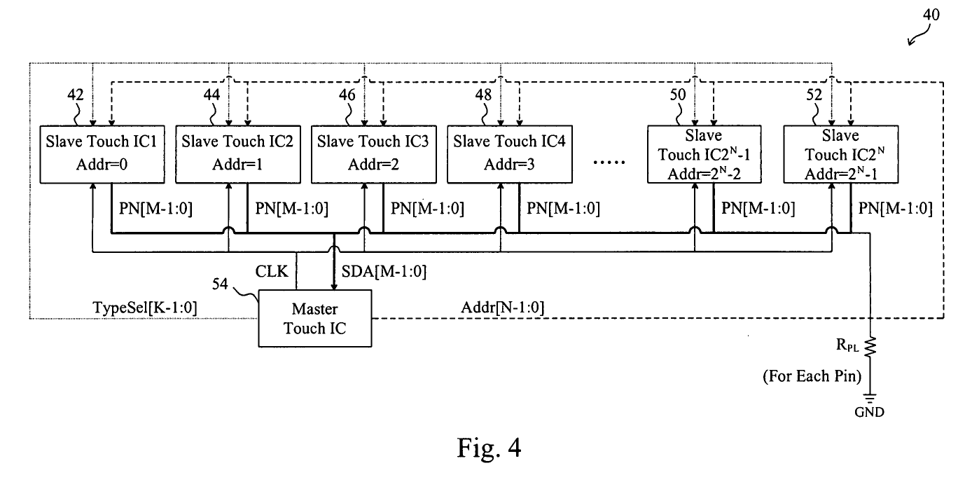

FIG. 4 is a schematic diagram of an embodiment according to the present invention, which adds a suspend mode into a capacitive touch system 40 to reduce the overall power consumption of the capacitive touch system 40. This capacitive touch system 40 uses 2N AI projected capacitance touch ICs 42, 44, 46, 48, 50 and 52, where N is a natural number, as slave touch ICs to simultaneously scan a touch panel (not shown). If some of the scanning zone of the slave touch ICs 42-52 are not touched for a long time, their responsible slave touch ICs will enter the suspend mode and thereafter scan at a longer interval to reduce power consumption of the capacitive touch system 40. A master touch IC 54 sends a clock CLK to each of the slave touch ICs 42-52 and receives the sensed data therefrom for computation. In this embodiment, each of the slave touch ICs 42-52 has a pin PN[M-1:0] to send a signal SDA[M-1:0] carrying its sensed data to the master touch IC 54, and the pins PN[M-1:0] of all the slave touch ICs 42-52 are connected together to the master touch IC 54. To prevent collision between the sensed data from the slave touch ICs 42-52, the master touch IC 54 sends an address signal Addr[N-1:0] to each of the slave touch ICs 42-52 to select therefrom to transmit its sensed data. For example, the address signal Addr[N-1:0] of “0” signifies that the slave touch IC 42 is requested to send its sensed data to the master touch IC 54, and in this case the pins PN[M-1:0] of all the other slave touch ICs 44-52 are set in a high impedance or floating. In addition, the master touch IC 54 sends a selection signal Typesel[K-1:0] to each of the slave touch ICs 42-52 to select the data format for the data transmission of the sensed data it desires to receive. A pull-down resistor RPL is connected between the pin PN[M-1:0] of each of the slave touch ICs 42-52 and a ground terminal GND.

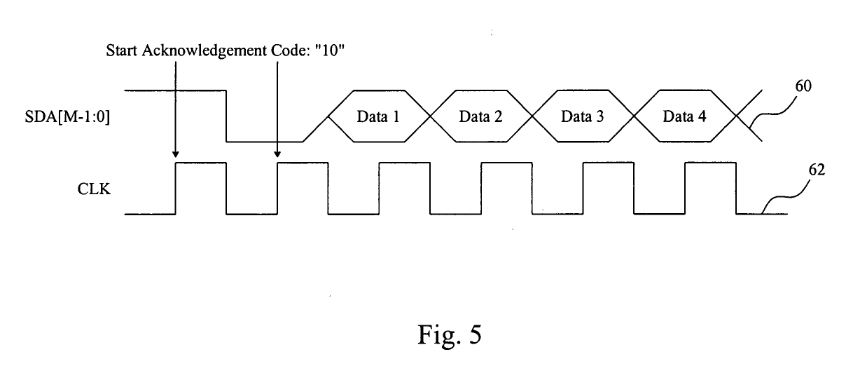

For the master touch IC 54 to read the sensed data from any one of the slave touch ICs 42-52, the slave touch ICs will send out a password of several timing cycles as a packet start acknowledgement code. Taking an example that the sensed data is transmitted with one bit width, i.e., M=1, FIG. 5 is a timing diagram of the signal SDA[M-1:0] sent by one of the slave touch ICs 42-52 to the master touch IC 54 under normal mode. The waveform 60 represents the signal SDA[M-1:0] and the waveform 62 represents the clock CLK. In this embodiment, the signal SDA[M-1:0] has one bit and the password has two timing cycles. Upon the detection of an address signal Addr[N-1:0] directing to itself, a particular one of the slave touch ICs 42-52 pulls up the signal SDA[M-1:0] and waits for the master touch IC 54 to send out the clock CLK to alter the data. The master touch IC 54 reads data at the rising edge of the clock CLK, and therefore, in a normal transmission mode, the master touch IC 54 will not start reading data until it detects a signal SDA[M-1:0] having a start acknowledgement code of “1” followed by “0”. If some of the scanning zones of the slave touch ICs 42-52 have not been touched for a long time, their responsible slave touch ICs will enter the suspend mode and thereafter scan their responsible scanning zone at a longer interval. Even a slave touch IC is in the suspend mode, the master touch IC 54 still keeps requesting sensed data therefrom for each frame. Besides, as mentioned above, only when a slave touch IC detects the address signal Addr[N-1:0] sent by the master touch IC 54 directing to it, it will set the signal SDA[M-1:0] as “1” or “0” while all the other slave touch ICs are set in a high impedance or floating. Thus, if the master touch IC 54 requests sensed data from, say, the slave touch IC 42, which happens to be in the suspend mode and cannot respond, the pull-down resistor R_{PL} will pull down the level of the pin PN[M-1:0] of the slave touch IC 42 to “0”, so that the master touch IC 54 detects no such start acknowledgement codes as “10” in the signal SDA[M-1:0], skips the slave touch IC 42 and moves on to request sensed data from the next slave touch IC 44.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A power saving capacitive touch system, comprising;
a touch panel;
at least two first integrated circuits connected to the touch panel to simultaneously scan thereto, each of the first integrated circuits responsible for scanning a respective portion of the touch panel; and
a second integrated circuit connected to the first integrated circuits to receive sensed data therefrom and calculate therewith;
wherein any one of the first integrated circuits will enter a suspend mode to lower a scanning frequency thereof when it has not detected any objects on its scanning zone for a predetermined period.

2. The capacitive touch system of claim 1, wherein each of the first integrated circuits has at least a pin to transmit its sensed data to the second integrated circuit.

3. The capacitive touch system of claim 2, wherein the second integrated circuit detects the level of the at least a pin of one of the first integrated circuits to determine whether or not to read sensed data therefrom.

4. The capacitive touch system of claim 3, further comprising a resistor connected between the at least a pin of each of the first integrated circuits and a ground terminal, to pull down the level of the at least a pin to the voltage of the ground terminal when the one of the first integrated circuits is in the suspend mode.

5. The capacitive touch system of claim 1, wherein each of the first integrated circuits comprises an axis intersect projected capacitance touch integrated circuit.

6. The capacitive touch system of claim 1, wherein the second integrated circuit sends a selection signal to one of the first integrated circuits to select a data format for the one of the first integrated circuits to transmit its sensed data to the second integrated circuit.

7. The capacitive touch system of claim 1, wherein the second integrated circuit sends a clock to each of the first integrated circuits.

8. The capacitive touch system of claim 1, wherein the second integrated circuit scans a respective portion of the touch panel.

9. A power saving method for a capacitive touch system including a touch panel simultaneously scanned by at least two first integrated circuits, and a second integrated circuit to receive sensed data from the first integrated circuits and calculate therewith, the method comprising:
each of the first integrated circuits scanning its responsible scanning zone at a high frequency when an object is detected thereon; and
if any one of the first integrated circuits has not detected any objects on its scanning zone for a predetermined period, it lowering its scanning frequency for power saving.

10. The power saving method of claim 9, further comprising providing an acknowledgement code by one of the first integrated circuits, for the second integrated circuit to determine whether or not to read sensed data from the one of the first integrated circuits.

11. The power saving method of claim 9, further comprising selecting a data format for one of the first integrated circuits to transmit its sensed data to the second integrated circuit.

12. The power saving method of claim 9, further comprising providing a clock for each of the first integrated circuits by the second integrated circuit.
